(19) United States
(12) Patent Application Publication
(10) Pub. No.: US 2022/0242500 A1
(43) Pub. Date: Aug. 4, 2022

(54) DEBRIS RETAINING COVER FOR A WORK MACHINE WITH ENDLESS TRACKS

(71) Applicant: CM PLANT HIRE LTD, Enniskillen, Northern Ireland (GB)

(72) Inventors: Cathal Peter Maguire, Glasgow (GB); Aaron Anthony Lee, Yokine (AU)

(21) Appl. No.: 17/618,741

(22) PCT Filed: Jun. 15, 2020
(86) PCT No.: PCT/GB2020/051440

§ 371 Date: Dec. 13, 2021

(30) Foreign Application Priority Data
Jun. 14, 2019 (GB) 1908541.4

(51) Int. Cl. B62D 55/08; B60J 11/06

(52) U.S. Cl. CPC B62D 55/08; B60J 11/06

(57) ABSTRACT

The invention relates to a debris retaining cover for retaining debris in the region of an undercarriage of a track-type vehicle. The cover includes a barrier member which provides a barrier to restrict egress of debris from the undercarriage of the vehicle and an attachment mechanism which is arranged to secure the barrier member across an undercarriage of the vehicle. A track-type vehicle provided with the debris retaining cover is also disclosed.

The present invention relates to a debris retaining cover, particularly, but not exclusively, a cover for retaining debris in the region of an undercarriage of a track-type vehicle to allow safe transportation of the track-type vehicle to an appropriate site for cleaning and removal of debris.

During use of plant machines having a revolving track, the track has a tendency to become clogged with mud and debris. After use, the mud and debris must be removed before the plant machine is transported on a low-loader vehicle. Removal of the debris on a work site can be difficult and time consuming.

According to a first aspect of the present invention there is provided a debris retaining cover for retaining debris in the region of an undercarriage of a track-type vehicle, the debris retaining cover comprising:
a barrier member adapted to provide a barrier to substantially restrict egress of debris from the undercarriage; and
an attachment mechanism arranged to secure the barrier member across at least a portion of an undercarriage of a track-type vehicle.

The debris retaining cover is advantageous since it enables plant machines to be transported on a low-loader following use, without the need for time consuming cleaning on a work or building site. Dried mud or debris may fall from the tracks during transportation, but it is retained in the region of the undercarriage by the cover. Thus, the debris retaining cover substantially restricts egress of debris from the region around the tracks allowing transportation of such plant machines on public roads without hazard to other road users.

Optionally, the barrier member is shaped to cover at least a portion of the tracks of the track-type vehicle. Optionally, the barrier member is shaped to cover at least a portion of an area defined by an edge of the tracks of the track-type vehicle.

Optionally, the barrier member is shaped and arranged to substantially cover one outward facing side of the tracks of the track-type vehicle. Optionally, the barrier member is shaped to substantially cover an area defined by a perimeter edge of the external track of the track-type vehicle.

Optionally, the barrier member comprises a flexible material. Optionally, the barrier member comprises a durable tough material. It is advantageous to provide a durable barrier member to withstand the forces acting on the barrier member during transport and to enable repeated use of the cover.

Optionally, the barrier member comprises a weather-resistant material. Optionally, the barrier member comprises an impermeable material. It is advantageous to provide an impermeable barrier member to avoid escape of dust particles through the cover.

Optionally, the barrier member comprises a synthetic material. Optionally, the barrier member comprises a recycled material. The barrier member may comprise a tarpaulin-type material.

Optionally, the barrier member has a centrally located advertising portion. Optionally, the advertising portion of the barrier member is arranged to display an advert or logo.

Optionally, the advertising portion is attached in a substantially central position on an outward face of the barrier member. The advertising portion displaying the advert or logo may be attached by sewing, bonding, adhesive or the like.

Optionally, dimensions of the barrier member are selected according to the track-type vehicle intended for use with the debris retaining cover. Optionally dimensions of the barrier member may be predetermined for use with smaller track-type vehicles in the range between 10-20 tonnes. Optionally dimensions of the barrier member may be predetermined for use with larger track-type vehicles in the range between 20-30 tonnes. Alternatively, the shape and dimensions of the barrier member may be bespoke and tailored to a specific track-type vehicle.

Optionally, the attachment mechanism may comprise straps for attaching the barrier member to a portion of an undercarriage of a track-type vehicle. Thus, the attachment mechanism functions to secure the barrier member in place across a portion of the undercarriage of a track-type vehicle.

The straps may be fixed to the barrier member at one end and comprise an attachment portion located towards another end. The straps may be fixed to the barrier member by sewing, adhesive, bonding or the like. The attachment portion of the straps may comprise a hooked portion. The hooked portion may be shaped and arranged to hook onto an inner edge of a track.

Optionally, the attachment mechanism may comprise a tensioner to enable tensioning and substantially restrict movement of the barrier member when in use or in a deployed configuration. The tensioner is advantageous, since the tensioner can ensure that the barrier member is taut to prevent it from becoming dislodged or flapping in the airflow during transportation on a low-loader vehicle.

Optionally, the tensioner is coupled to the straps and is adjustable to alter the amount of tension in the straps of the attachment mechanism. Optionally, the tensioner may comprise a ratchet-type mechanism.

Optionally, the attachment mechanism comprises haulage tensioning straps.

Optionally, dimensions of the straps may be selected according to the track-type vehicle. Thus, the size and length of straps may be specific to an individual track-type vehicle model or may be specific to a certain category of machine.

Optionally, the debris retaining cover is moveable between a stowed configuration and a deployed configuration.

Optionally, the barrier member and/or the attachment mechanism are movable into a compact position to facilitate storage in the stowed configuration. Optionally, the barrier member and/or the attachment mechanism are foldable into the stowed configuration.

Optionally, the debris retaining cover further comprises a housing for housing the barrier member and attachment mechanism. Optionally, the debris retaining cover and/or the barrier member are housed within the housing in the stowed configuration. The housing may comprise a bag, a case or a box shaped and arranged to accommodate the debris retaining cover.

Optionally the barrier member is secured to a portion of the undercarriage of a track-type vehicle by means of the attachment mechanism in the deployed configuration. Optionally, the debris retaining cover is movable into the deployed configuration only when the track-type vehicle is stationary.

Alternatively, the barrier member may comprise a rigid cover. Optionally, the rigid cover comprises sheet aluminium.

Optionally, the rigid cover comprises two portions slidable between an open configuration and a closed deployed configuration. The open configuration may allow fitting and removal of the debris retaining cover to the tracks of the track type vehicle.

Optionally, the two portions overlap to form a substantially continuous barrier in the deployed configuration. The debris retaining cover may be secured to the tracks of the track type vehicle via the attachment mechanism in the closed deployed configuration.

Optionally at least two debris retaining covers may be provided for each track-type vehicle.

Optionally, the rigid cover may comprise at least a hinged section which allows at least a first panel of the cover to be folded over onto at least a second panel of the cover.

Optionally, three hinges are provided such that four panels may be folded over onto one another.

According to a second aspect of the present invention there is provided a track-type vehicle comprising at least one debris retaining cover according to the first aspect of the invention.

Further features and advantages of the first and second aspects of the present invention will become apparent from the claims and the following description. Any feature, embodiment or aspect of the invention may be used in conjunction with the first and second aspects of the invention where appropriate.

Embodiments of the present invention will now be described by way of example only, with reference to the following diagrams, in which:—

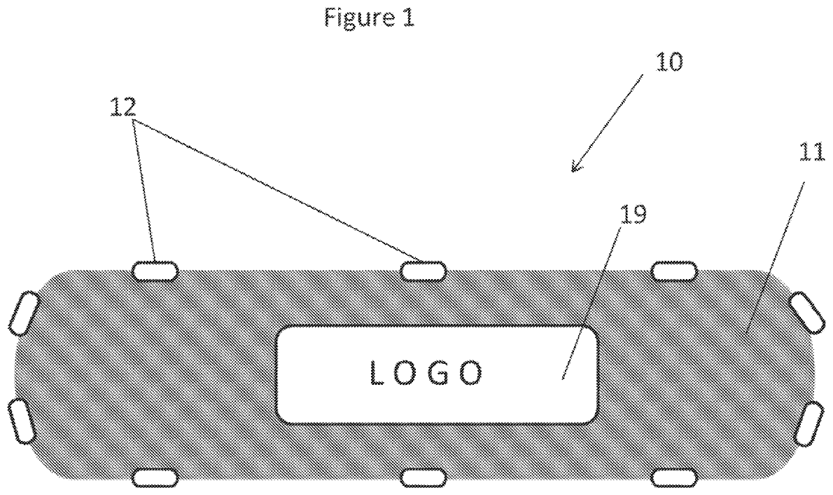

FIG. 1 is a schematic side view of a debris retaining cover fitted to a track of a plant machine;

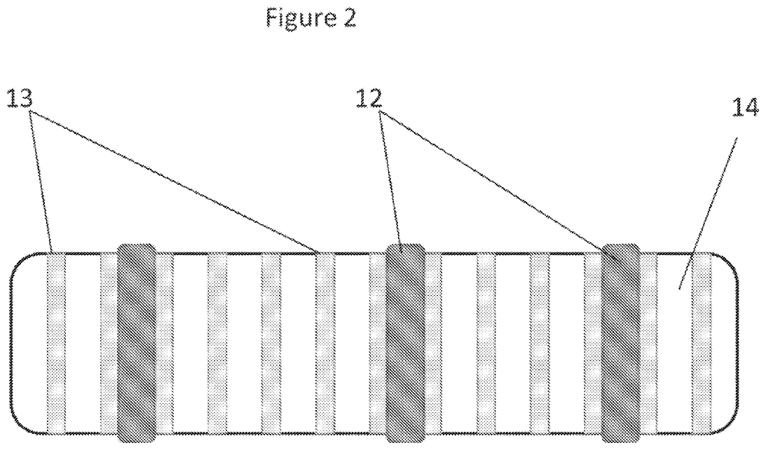

FIG. 2 is a schematic plan view of the tracks of the machine and straps of the debris retaining cover of FIG. 1;

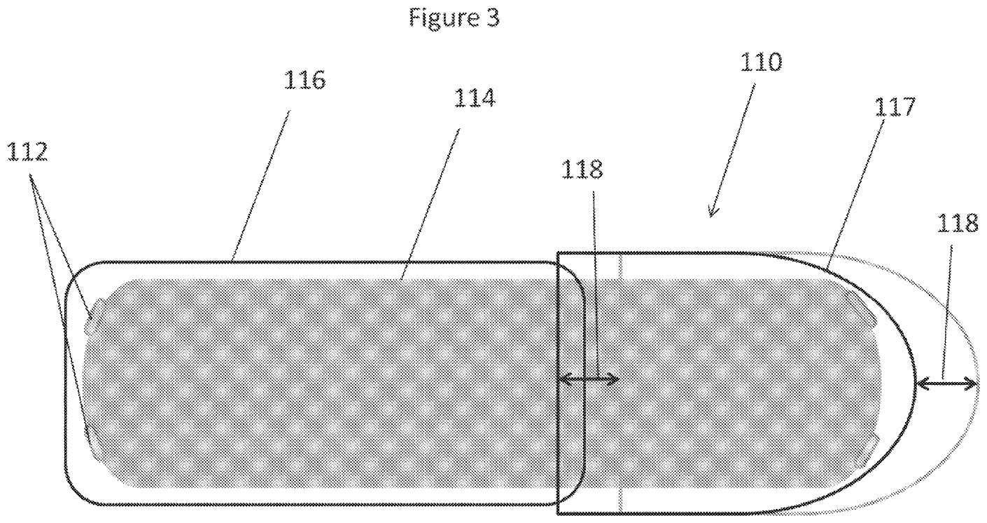

FIG. 3 is a schematic part-cutaway side view of an alternative debris retaining cover comprising two rigid barrier portions; and

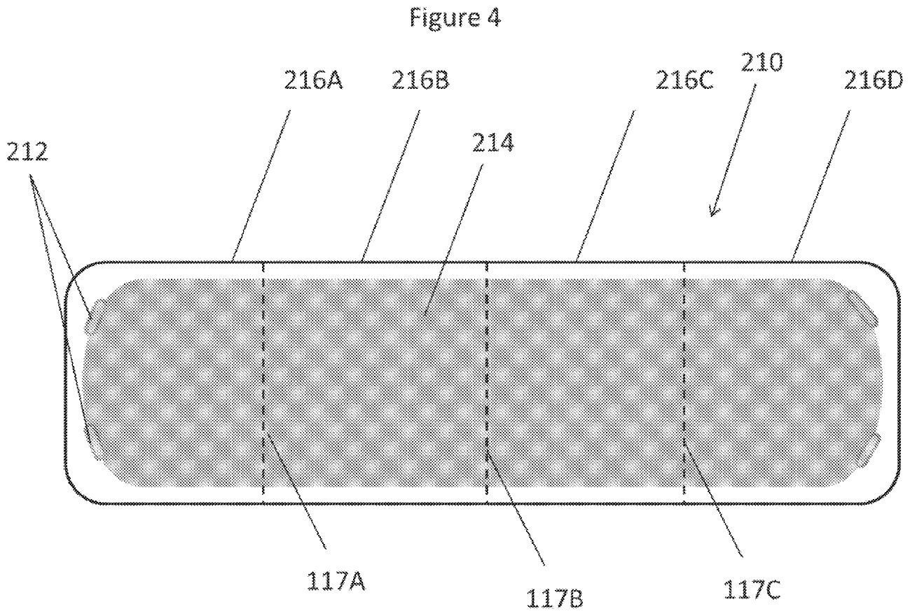

FIG. 4 is a schematic part-cutaway side view of an alternative debris retaining cover comprising four hinged barrier portions.

An undercarriage of a large plant machine (not shown) includes a pair of revolving tracks 14, one on each side of the vehicle, that are driven by rollers to move the large plant machine around a work site. During use of the large plant machine loose material from a work site such as gravel and mud become stuck in the undercarriage. Removal of such debris is time consuming and difficult in situ on the work site. However, transportation of the plant machine is unsafe without prior cleaning of the undercarriage, due to the potential for debris to work loose and fall on the roads causing a hazard for other road users. According to the present invention, when the large plant machine is stationary, a debris retaining cover shown generally at 10 in FIG. 1 is deployed. The debris retaining cover 10 is shown in a deployed configuration covering one side face defined by an outer edge of the tracks 14 of the large plant machine. The debris retaining cover 10, use, storage and deployment thereof, is described in detail below.

The debris retaining cover 10 comprises a barrier member in the form of a durable, impermeable, flexible, weather-resistant barrier 11 made from recycled materials. An outer face of the barrier 11 contains a substantially centrally positioned advertising portion 19 suitable for displaying a logo or other form of advertising. The advertising portion 19 may be printed directly, sewed, bonded or otherwise attached to the barrier 11. Provision of advertising space by placement of the advertising portion 19 on the cover 10 itself, may enable the cover 10 to be self-financing, cost-neutral and/or generate advertising revenue.

The debris retaining cover 10 additionally comprises an attachment mechanism in the form of a plurality of haulage straps 12 with ratchet tensioners (not shown) spaced at intervals around the exterior of the barrier 11. One leading end of each haulage strap 12 is sewed to an edge of the barrier member 11. A metal hook (not shown) is provided towards a distal end of each haulage strap 12. The hook is shaped to hook onto the inner edge of the track 14 in use. A ratchet tensioner is located on each strap to enable easy attachment of slack straps via the hooks and allow the straps to be subsequently tightened by adjusting the tension of the straps 12 thereafter.

As shown in the plan view of FIG. 2, the tracks 14 comprise a series of transverse ridges 13 to aid grip when the plant machine is in use. In the deployed configuration, the straps 12 are located in grooves between the ridges 14.

When the plant machine is returned to a base for cleaning, the debris retaining cover 10 is no longer required and may be moved from the deployed configuration into a stowed configuration. The debris retaining cover 10 is stored in a hard case or bag (not shown). The barrier 11 and straps 12 fold into the stowed configuration to enable the cover 10 to be stored easily within the case. Each case contains two such debris covers so that a cover 10 is provided for the tracks 14 on each side of the plant machine. The case containing the debris cover 10 may be stored inside the plant machine for future use and deployment again as required.

Following further use of the plant machine on a building or work site, the tracks 14 become muddy and covered with debris. The plant machine cannot be transported on a low-loader on public roads in such a condition due to the potential for clods of earth to fall onto the roads causing a potential hazard for other road users. Therefore, an operator retrieves the case containing the debris covers 10 in the stowed configurations and places each debris cover 10 in the deployed configuration over the outward facing edge of the tracks 14. Each debris cover 10 is moved from the stowed configuration to the deployed configuration by unfolding the barrier 11 and straps 12, and spreading the barrier 11 across the outward face of the tracks 14. The barrier 11 is secured by hooking the hooks on each strap 12 over the internal edge of the tracks 14. The straps 12 are then tightened using the tensioners such that they will not flap or move in the airflow during transportation of the plant machine.

Once the debris covers 10 are in the deployed configuration the track vehicle is ready for transportation on a low-loader vehicle. The tensioned barrier 11 is securely attached such that it is immovable during transportation. The barrier 11 is impermeable to prevent egress of dust and other small particles therethrough. Any debris falling from the tracks 14 is contained by the barrier 11 between the interior of the barrier 11 and the tracks 14. Debris is thus retained and prevented from spilling onto the road. During transportation, the cover 10 is used to display a company logo and/or advertising information on the advertising portion 19.

According to the present embodiment, two debris retaining covers 10 are provided over the outward facing tracks 14. Debris falling from an internal side of the tracks 14 drops into a recessed portion of the low-loader vehicle and therefore is retained and restricted from spillage onto a public road. However, an operator may use additional debris retaining covers 10 to cover the internal tracks 14 in addition to the outward facing tracks 14.

With reference to FIG. 3, a further embodiment of the present invention will now be described. In order to minimise repetition, similar features described subsequently are numbered with a common two-digit reference numeral and are differentiated by a third digit ‘1’ placed before the two common digits. Such features are structured similarly, operate similarly, and/or have similar functions as previously described unless otherwise indicated.

According to another embodiment of the invention shown in FIG. 3, the debris retaining cover 110 is made from a first and a second thin rigid aluminium shell 116, 117. The second shell 117 is slidable as depicted by an arrow 118 between an open configuration, allowing the shell to be placed in the region of the tracks 114, and a closed overlapping configuration, in which the second shell 117 overlaps the first shell 116 to form a continuous barrier for retaining debris therein. In the closed configuration, the aluminium shells 116, 117 are secured to one another and attached to the tracks 114 by the attachment mechanism at attachment points 112. In an alternative embodiment (not shown) several slidable covers may be provided—each arranged to overlap the other in order to minimise the dimensions of the cover when all slidable covers are slid on top of one another.

With reference to FIG. 4, a further embodiment of the present invention will now be described. In order to minimise repetition, similar features described subsequently are numbered with a common two-digit reference numeral and are differentiated by a third digit ‘2’ placed before the two common digits. Such features are structured similarly, operate similarly, and/or have similar functions as previously described unless otherwise indicated.

According to another embodiment of the invention shown in FIG. 4, the debris retaining cover 210 comprises a thin rigid aluminium shell which is divided into a series of four panels 216A, 216B, 216C, 216D. At the join between each of the panels 216A, 216B, 216C, 216D a hinged arrangement (depicted by dashed lines 217A, 217B, 217C) is provided. This allows the panels to form a continuous barrier for retaining debris therein when the hinges are opened out and the panels are aligned with one another. In the closed configuration, the panels 216A, 216B, 216C, 216D are folded onto one another around the hinges 217A, 217B, 217C such that the resultant folded arrangement may be stowed away.

Although three hinges and four panels are described in the embodiment previously described, the reader will appreciate that many fewer or greater hinges and associated panels may alternatively be utilised depending upon requirements.

Although particular embodiments of the invention have been disclosed herein in detail, this is by way of example and for the purposes of illustration only. The aforementioned embodiments are not intended to be limiting with respect to the scope of the statements of invention and/or appended claims. Relative terms such as “inner”, “outward” and the like are illustrative only.

“Debris” as used herein is intended to refer to any substance that becomes attached to the undercarriage of the track-type vehicle and may include, but is not limited to the following examples; mud, gravel, sand, soil, snow, clay, rocks, dirt, stones, pebbles and the like.

“Track-type vehicle” as used herein is intended to cover any vehicle or machine having endless revolving tracks powered by rollers.

Specifications of the debris retaining cover 10, 110, such as dimensions, strength and material selection may be made according to the anticipated use and matched to each specific plant machine. Alternatively or additionally, there may be standard sizes available, such as a debris retaining cover 10, 110 suitable for use with 10-20 tonne machines and another debris retaining cover 10, 110 suitable for use with 20-30 tonne machines.

It is contemplated by the inventors that various substitutions, alterations, and modifications may be made to the invention without departing from the scope of the invention as defined by the statements of invention and/or claims. One such example is provided below.

Although the first embodiment specifies a case containing two debris retaining covers 10, each case, bag or box may contain several debris retaining covers for use on different sides of the plant machine's tracks 14. For example, debris retaining covers 10 may be used on both the interior and the exterior of each set of tracks 14.

1. A debris retaining cover for retaining debris in a region of an undercarriage of a track-type vehicle, the debris retaining cover comprising:
a barrier member adapted to provide a barrier to substantially restrict egress of debris from the undercarriage; and
an attachment mechanism arranged to secure the barrier member across at least a portion of an undercarriage of a track-type vehicle.

2. A debris retaining cover according to claim 1, wherein the barrier member is shaped to cover at least a portion of an area defined by an edge of the tracks of the track-type vehicle.

3. A debris retaining cover according to claim 1, wherein the barrier member comprises a flexible impermeable material.

4. A debris retaining cover according to claim 1, wherein the barrier member comprises a tarpaulin-type material.

5. A debris retaining cover according to claim 1, wherein the attachment mechanism comprises straps adapted to attach the barrier member to a portion of an undercarriage of a track-type vehicle.

6. A debris retaining cover according to claim 5, wherein the straps are fixed to the barrier member at one end and comprise an attachment portion located towards an opposing end, and wherein the attachment portion is arranged to attach the straps to the tracks of the track-type vehicle in use.

7. A debris retaining cover according to claim 6, wherein the straps are fixed to the barrier member by at least one means selected from the group consisting of: sewing, adhesive, and bonding.

8. A debris retaining cover according to claim 6, wherein the attachment portion of the attachment mechanism comprises a hooked portion that is shaped and arranged to hook onto an inner edge of a track-type vehicle.

9. A debris retaining cover according to claim 6, wherein the attachment mechanism comprises a tensioner to substantially restrict movement of the barrier member when in use or in a deployed configuration, wherein the tensioner is coupled to the straps and adjustable to alter an amount of tension in the straps of the attachment mechanism.

10. A debris retaining cover according to claim 9, wherein the tensioner comprises a ratchet-type mechanism.

11. A debris retaining cover according to claim 1, wherein the attachment mechanism comprises haulage tensioning straps.

12. A debris retaining cover according to claim 1, wherein dimensions of the barrier member and attachment mechanism are pre-selected according to a specific size of an individual track-type vehicle for use with the debris retaining cover, or, a certain category of track-type vehicle.

13. A debris retaining cover according to claim 1, wherein the debris retaining cover is moveable between a stowed configuration and a deployed configuration.

14. A debris retaining cover according to claim 13, wherein the barrier member and/or the attachment mechanism are foldable into a compact position to facilitate storage into the stowed configuration.

15. A debris retaining cover according to claim 13, wherein the debris retaining cover comprises a housing for housing the barrier member and attachment mechanism in the stowed configuration.

16. A debris retaining cover according to claim 13, wherein the barrier member is securable to a portion of the undercarriage of a track-type vehicle when the track-type vehicle is stationary, by means of the attachment mechanism, and wherein the debris retaining cover substantially restricts egress of debris from the tracks in the deployed configuration.

17. A debris retaining cover according to claim 1, wherein the barrier member comprises a rigid cover having two portions slidable between an open configuration and a closed deployed configuration.

18. A debris retaining cover according to claim 17, wherein the rigid cover comprises sheet aluminium.

19. A track-type vehicle comprising at least one debris retaining cover according to claim 1.
